(19) United States
(12) Patent Application Publication
(10) Pub. No.: US 2026/0030016 A1
(43) Pub. Date: Jan. 29, 2026

(54) CUSTOM UPDATE APPLICATIONS FOR UNSUPPORTED SOFTWARE

(71) Applicant: Ivanti, Inc., South Jordan, UT (US)

(72) Inventors: Josh Howard, South Jordan, UT (US); Ranjith Chalavadhi, Nashville, TN (US); Ethan Larson, St. Louis Park, MN (US)

(73) Assignee: Ivanti, Inc., South Jordan, UT (US)

(21) Appl. No.: 19/277,290

(22) Filed: Jul. 22, 2025

Related U.S. Application Data
(60) Provisional application No. 63/674,738, filed on Jul. 23, 2024.

(51) Int. Cl. G06F 8/65

(52) U.S. Cl. CPC G06F 8/65

(57) ABSTRACT

An embodiment includes a method of management of unsupported applications in a managed network. The method includes receiving information that identifies the unsupported application that is not updated by a product update system. The method includes obtaining prerequisite detection logic metadata configured to identify an instance of the unsupported application installed at an endpoint. The method includes generating a post-install detection logic and installation instructions. The method includes pre-populating an update system with the prerequisite detection logic metadata, the post install detection logic, and the installation instructions to generate a custom update application. The method includes receiving an indication of an outstanding update to the unsupported application and generating a patch package for the unsupported application based on the custom update application. The method includes causing distribution of the patch package causing a change in a state of the unsupported application.

### CROSS-REFERENCE TO RELATED APPLICATION

This application claims the benefit of and priority to U.S. Provisional Application No. 63/674,738, filed Jul. 23, 2024, which is incorporated herein by reference in its entirety.

### FIELD

The examples described in this disclosure are related to automated endpoint product management, and in particular to custom update application generation and implementation for unsupported software.

### BACKGROUND

Patching in a managed network can be performed using a third-party system or service. These third-party systems may be primarily directed to software that was developed or distributed by the third party. Accordingly, the third-party systems may have limited ability to patch or update software that is developed by other entities. In the managed networks implementing the third-party systems, administrators may manually patch the software developed by other entities or leave the software unpatched, which may lead to persistence of vulnerabilities in the managed network.

In some systems, applications can be added that enable update management of the software developed by other entities. However, this process is difficult and error prone. For instance, adding the applications to the third-party system may involve download of a utility to package the installer files (e.g., .msi files and .exe files) creating and uploading packages, and manually specifying how to detect prerequisites, how to detect a successful installation, and installation commands.

In some managed networks, service providers (other than the third party) may facilitate patching the software developed by other entities using the third-party system. The service providers may generate application packages that include an application that can be integrated into the third-party system. These service providers leverage the third-party system to distribute updates after the applications are integrated. However, it is difficult to properly generate the application packages. As indicated above, in-depth knowledge of the third-party system and the software is necessary. For instance, to enable digestion and integration by the third-party system, the application packages must include proper identifying information, command prompts, etc. that enable distribution and execution.

The service providers may generate multiple applications for a portion of the software not managed by the third-party systems. These applications are provided as part of a management service and enable management of the portion of the software not managed by the third-party system. However, the service providers do not address all software that is not managed by the third-party system. For instance, the service provider may not generate applications for customer-specific software or for obscure, infrequently used software. This unsupported software is left unmanaged, which may result in the persistence of vulnerabilities and malfunctioning software.

Thus, there is a need in conventional patch systems to generate or automatically generate application packages that enable integration by a third-party system of an application for an unsupported software.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment may include a method of product update management of unsupported software in a managed network. The method may include receiving unsupported software information that identifies an unsupported software. The unsupported software may include a software application that is not updated by a third-party system or a product update system that augments management services of the third-party system. The method may include obtaining prerequisite detection logic metadata related to the unsupported software as deployed in a managed network. The prerequisite detection logic metadata may be configured to identify an instance of the unsupported software installed at an endpoint included in the managed network. The method may include generating a post-install detection logic and installation instructions at least partially based on the prerequisite detection logic metadata. The method may include pre-populating a product update system with the prerequisite detection logic metadata, the post-install detection logic, and the installation instructions to generate a custom application package for the unsupported software. The method may include communicating the custom application package to the third-party system such that the third-party system integrates the unsupported software into a management service configured to distribute product updates to the endpoint and such that responsive to an indication of a product update directed to the unsupported software, the third-party system generates and distributes a patch package for the unsupported software based on the custom application package.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments of the present disclosure may be implemented;

FIG. 2A depicts a setup phase of the product update management process;

FIG. 2B depicts an implementation phase of the product update management process;

FIG. 3 depicts a block diagram of an AI-based logic and instruction generation process that may be implemented in the product update management process of FIGS. 2A and 2B;

FIG. 4 depicts a block diagram of example US definition data that may be implemented in the product update management process of FIGS. 2A and 2B;

FIGS. 5A and 5B are a flow chart of an example method of product update management of unsupported software in a managed network;

FIG. 6 is a flow chart of an example method of AI-based logic and instruction generation;

FIG. 7 illustrates an example computer system configured of product update management of unsupported software in a managed network;

FIG. 8 is a screenshot of an example first user interface (UX) that may be implemented in the product update management process of FIGS. 2A and 2B;

FIG. 9 is a screenshot of an example second UX that may be implemented in the product update management process of FIGS. 2A and 2B; and

FIG. 10 depicts an example patch management UX that may be implemented in the product update management process of FIGS. 2A and 2B,

all according to at least one embodiment described in the present disclosure.

### DESCRIPTION OF SOME EXAMPLE EMBODIMENTS

The embodiments described in this disclosure are related to automated endpoint product management, and in particular generation of custom update application and custom application packages for unsupported software. The custom application packages enable integration by a third-party system such that the unsupported software is managed by the third-party system.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

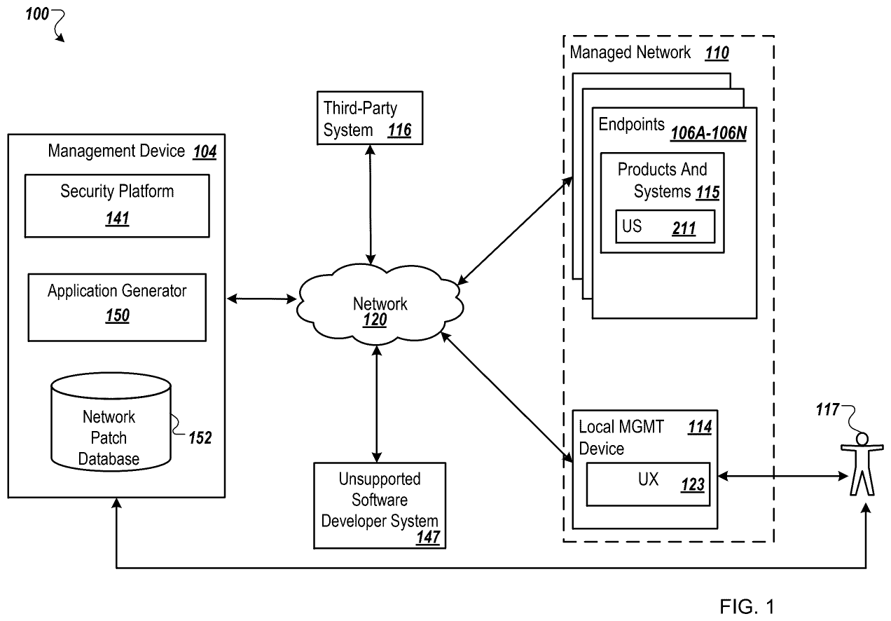

FIG. 1 is a block diagram of an example operating environment 100 in which some examples of the present disclosure can be implemented. The operating environment 100 may be configured for implementation of product update management of a managed network 110. The product update management may enable product updates such as patches and code changes to be accessed, consumed, and distributed to endpoints 106A-106N (generally, endpoint 106 or endpoints 106) of the managed network 110.

In the operating environment 100, a third-party system 116 may be primarily tasked with update or patch management of the managed network 110. For instance, the third-party system 116 may implement an endpoint management tool or a mobile device management (MDM) service. Incorporated in the endpoint management tool or the MDM service may be an application management service that operates to keep products and systems (hereinafter, “products”) 115 up-to-date according to a policy and/or update settings.

The third-party system 116 is not configured to provide update management relative to all the products 115. For instance, the products 115 may include a first portion that are developed or distributed by the third-party system 116. The third-party system 116 may be configured to regularly update the first portion of the products 115. For instance, an example of the third-party system 116 may be Microsoft® Intune®. The first portion of the products 115 may include Microsoft products such as Windows®, Word®, Excel®, etc. Intune may be configured to distribute updates to the Microsoft products by default.

The products 115 may also include a second portion. The second portion may not be developed or distributed by the third-party system 116. For instance, from the immediately preceding example, the second portion of the products 115 may include applications developed by other vendors such as Adobe® and an unsupported software (US) developer system 147. Intune is not configured to provide updates to Adobe products or to an unsupported software 211 that is developed by the US developer system 147. However, the second portion of the products 115 may still require update management to ensure vulnerabilities are addressed and the products 115 function properly.

The operating environment 100 includes a management device 104 that includes a security platform 141 and an application generator 150. The management device 104 is configured to support or augment the update management performed by the third-party system 116 and provide additional update management services to the managed network 110. For instance, the security platform 141 is configured to provide additional controls of the update management performed by the third-party system 116 relative to the first portion of the products 115. In addition, the security platform 141 may be configured to integrate known or common application packages (hereinafter, “known application packages”) into the third-party system 116.

The known application packages may be received by the third-party system 116, which enables the third-party system 116 to distribute updates to the endpoints 106. Of the second portion of the products 115, there may be broadly used products 115 such as the Adobe software and an unsupported software (hereinafter, “US”) 211. A service provider associated with the management device 104 and the security platform 141 may build the known application package for the broadly used products 115. For the US 211, the application generator 150 may be implemented to build a custom application package 202 that includes a custom update application for the US 211. The custom application package 202 may enable integration of the custom update application into the third-party system 116 and incorporation into the security platform 141 such that the third-party system 116 and the security platform 141 can perform update management operations relative to the US 211.

For example, in the operating environment 100, a majority of the products 115 may be supported by the third-party system 116 by default or using a known application package uploaded by the security platform 141. This majority of the products 115 are designated herein as supported software. For instance, the supported products might include a first portion of the products 115 developed or distributed by the third-party system 116 and a second portion of the products 115 included in a catalog developed by the security platform 141. The security platform 141 may have assembled and defined detection logic, product information, metadata, installation instructions, etc. related to the supported products. The security platform 141 generates known application packages that are integrated into the third-party system 116 such that the third-party system 116 is able to generate and/or distribute patch packages to the endpoints 106. Specifically, a supported software might include Adobe Acrobat Reader™ and Microsoft Windows™.

In contrast, the security platform 141 and the third-party system 116 do not have access to detection logic, product information, metadata, installation instructions of the US 211. Accordingly, in conventional systems, the US 211 may remain in an unpatched or an out-of-date state, which may enable vulnerabilities to persist or interruptions in the function of the US 211. The application generator 150 is configured to generate custom application packages that includes a custom update application, which enables the management of the US 211 by the security platform 141 and the third-party system 116.

Some examples of the present disclosure improve conventional patch management systems and address the inefficiencies and technical issues described above. For instance, in some examples, the management device 104 generates a custom update application and a custom application package that is directed to the US 211. The custom update application enables patch and update management of the US 211. For instance, the augmented services provided by the security platform 141 are applicable to the US 211 and product updates directed to the US 211 may be distributed to the endpoints 106 by the third-party system 116.

Accordingly, examples of the present disclosure are directed to a computer-centric problem and are implemented in a computer-centric environment. For instance, the examples of the present disclosure are directed to product update management and product update deployment in the managed network 110. Computing processes occurring in the operating environment 100 include communication and implementation of product updates that include software patches and code changes on the products 115 loaded on the endpoints 106. Communications during the processes described in this present disclosure involve the communication of data in electronic and optical forms via a network 120 and also involve the electrical and optical interpretation of the data and information.

The operating environment 100 may include the managed network 110, the third-party system 116, the management device 104, and the US developer system 147. The managed network 110 may include a local management device 114 and the endpoints 106. The components of the operating environment 100 are configured to communicate data and information via the network 120 to perform generation and implementation of custom application packages including custom update applications that are configured to update the US 211 as described in the present disclosure. Each of these components are described below.

The network 120 may include any communication network configured for communication of signals between the components (e.g., 104, 116, 117, and 110) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOccan® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party system 116 may be a hardware-based server configured to communicate data and information with the other components of the operating environment 100 via the network 120. The third-party system 116 may be configured to distribute product updates (e.g., a code change or patch) or instructions related to product updates to the endpoints 106. For example, one or both of the endpoints 106 may receive instructions related to the product updates, access the product updates, and install the product updates according to received instructions. Installation of the product updates may modify code of one of the products 115 on the endpoints 106. The distribution of the product updates may be one part of an endpoint management service provided by the third-party system 116.

In some embodiments, the third-party system 116 may receive and/or host telemetry data from the endpoints 106. For instance, the third-party system 116 may obtain lists of the products 115 at the endpoints 106, which may be accessible to the management device 104. Additionally, the third-party system 116 may track or monitor whether product updates and patches are successfully installed at the endpoints 106, which may be indicative of whether a custom update application properly functions.

In the depicted example, the third-party system 116 is not included in the managed network 110. In some examples, the third-party system 116 or some portion thereof may be included in the managed network 110.

The managed network 110 includes the local management device 114 and the endpoints 106. The managed network 110 is implemented to enable management of the endpoints 106 by the management device 104 and the third-party system 116. To implement the managed network 110, the endpoints 106 may be enrolled. After the endpoints 106 are enrolled, ongoing management of the endpoints 106 may be implemented. The ongoing management may include overseeing and dictating at least a part of the operations at the endpoints 106 as well as dictate or control product updates implemented at the endpoints 106 as described in the present disclosure. The managed network 110 may be associated with an enterprise, a portion of an enterprise, a government entity, or another entity or set of devices.

The endpoints 106 may include hardware-based computer systems that are configured to communicate with the other components of the operating environment 100 via the network 120. The endpoints 106 may include any computer device that may be managed by the management device 104 or the third-party system 116 and/or have been enrolled in the managed network 110. Generally, the endpoints 106 include devices that are operated by the personnel and systems of an enterprise or store and process data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110.

The endpoints 106 include the products 115. The products 115 may include applications or subsystems of any kind or type. Some examples of the products 115 may include software applications, enterprise software, operating systems, the US 211, and the like. The product 115 may not be the same in all endpoints. For instance, a first set of products 115 of a first endpoint 106A may include a first set of software applications while a second set of products 115 on a second endpoint 106B may include a second set of software applications, which may include at least one software application that is not included in the first set of software applications. The products 115 may include the US 211. The US 211 is one of the products 115 that are not automatically patched or updated by the security platform 141 or the third-party system 116 without the custom update application generated by the application generator 150.

The third-party system 116 may monitor and access the information related to the products 115 without a client-side agent. In these embodiments, the third-party system 116 may implement agentless management to access the information related to the products 115. After the information is accessed by the third-party system 116, it becomes accessible to the management device 104 via the network 120.

The local management device 114 is configured to assist in product update management in the managed network 110. The local management device 114 may be associated with an administrator 117. The administrator 117 may be an individual, a set of individuals, or a system that interfaces with the local management device 114. In some examples, the administrator 117 may provide input to the local management device 114. The input provided by the administrator 117 may form the basis of some computing processes performed by the local management device 114. For example, the administrator 117 may provide US metadata (described below) or other user input at user interface (UX) 123 associated with the local management device 114. The user input may take the form of a selection of an icon or button on the local management device 114.

In some embodiments, the local management device 114 may include the security platform 141 and the application generator 150. In these and other embodiments, the update management service may be performed as an “on prem” service. In these and other embodiments, the management device 104 may be omitted or may not implement processes and operations related to generation and implementation of custom application packages and the custom update application. Instead, the local management device 114 may implement these processes and operations. In these and other embodiments, the local management device 114 may interface with the third-party system 116, the US developer system 147, or some combination thereof.

In some embodiments, the local management device 114 is one of the endpoints 106. For instance, the local management device 114 may include products 115. Additionally, in some embodiments, the local management device 114 may be omitted, and the administrator 117 may use one of the endpoints 106 to interface with the management device 104 (e.g., the application generator 150 and the security platform 141) remotely.

The US developer system 147 may include a hardware-based computer system that is configured to communicate with one or more of the components of the operating environment 100. In some embodiments, the US developer system 147 developed the US 211 and may continue to develop product updates or configuration updates related to the US 211. Alternatively, the US developer system 147 may not have developed the US 211, but may generate and/or distribute product updates for the US 211. For instance, after the US 211 is installed in one or more of the endpoints 106, the US developer system 147 may include a public repository on which a US product update is accessible. Additionally or alternatively, the US developer system 147 may be associated with an entity that developed the US 211 and may continue to update and patch the US 211.

In the operating environment 100, the US developer system 147 is outside the managed network 110. In some embodiments, the US developer system 147 may be a part of the managed network 110. For instance, the US 211 may be a corporate software that was developed internally to operate on the endpoints 106. Accordingly, in these and other embodiments, the US developer system 147 may be one of the endpoints 106 or otherwise included in the managed network 110.

The management device 104 may include a hardware-based computer system that is configured to communicate with the other components of the operating environment 100 via the network 120. In some examples, the management device 104 may be a single server, a set of servers, a virtual device, or a virtual server in a cloud-base network of servers. In these and other examples, the application generator 150 and/or the security platform 141 may be spread over two or more cores, which may be virtualized across multiple physical machines.

The management device 104 may be configured for management services related to the managed network 110. For instance, the management device 104 may supplement or augment update management performed by the third-party system 116. In general, management of the product updates may include determining which product updates pertain to the products 115 and the US 211. The management device 104 may be implemented to provide a customer portal that provides visibility of the products and implements controls and status information relative to the products 115.

The management device 104 may be associated with the administrator 117. The administrator 117 may provide input to the management device 104. The input provided by the administrator 117 may form the basis of some computing processes performed by the management device 104. For example, the administrator 117 may provide US metadata or other user input at a user interface associated with the management device 104. The user input may indicate that the administrator 117 intends on publishing a subset of recommended product updates. The user input may take the form of a selection of an icon or button on the management device 104.

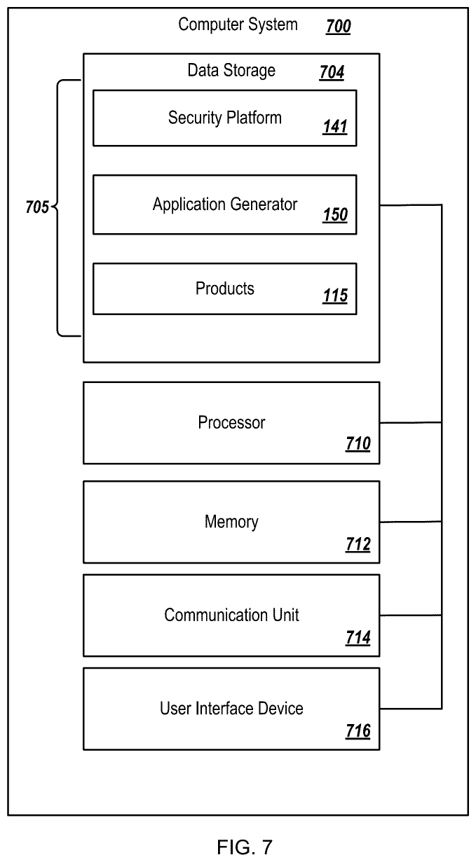

The management device 104 may include the security platform 141, a network patch database 152, and the application generator 150. The network patch database 152 is a non-transitory memory (e.g., 712 of FIG. 7). The network patch database 152 may be configured to store at least temporarily information and data related to the security platform 141. For instance, the custom update application, US metadata, scripts, installation instructions, detection logic, etc. may be stored at the network patch database 152. In some embodiments, the data stored in the network patch database 152 may be accessed by an artificial intelligence (AI) engine, which is discussed elsewhere in the present disclosure.

The application generator 150 and the security platform 141 may be configured for product update management of the US 211 in the managed network 110 using the third-party system 116. The application generator 150 may be configured to generate a custom update application and a custom application package for the US 211. The custom application package is used to integrate the custom update application into the third-party system 116 and into the security platform 141. Integration of the custom update application into the third-party system 116 allows for product updates to be managed and distributed by the third-party system 116. Integration into the security platform 141 enables the product updates of the US 211 to be monitored and managed.

To generate the custom update application, the application generator 150 may receive US metadata. The US metadata may be received from the administrator 117 or from the local management device 114 (e.g., by the administrator 117 via the UX 123). The US metadata may include identifying information of the US 211 and parameters of the US 211 that enables an application package to be generated. The application generator 150 may then obtain pre-requisite detection logic metadata that is related to the US 211 as deployed in the managed network 110. The application generator 150 may generate post-install detection logic and installation instructions for the US 211. The post-install detection logic enables the third-party system 116 to evaluate whether a patch package is received at the endpoint 106 and/or whether a product update of the US 211 is successfully installed at the endpoints 106. The installation instructions may include the operations performed at the endpoints 106 and the third-party system 116 to enable distribution and installation of the product update.

The application generator 150 may prepopulate the security platform 141 with the US metadata, the pre-requisite detection logic metadata, the post-install detection logic, installation instructions, or some combination thereof. Prepopulating the security platform 141 generates the custom update application and/or the application package for the US 211. The security platform 141 incorporates the custom update application into the patch management service.

After the custom update application is incorporated into the patch management service, the security platform 141 may enable management of the US 211. For instance, the US 211 may be incorporated into a customer portal, which may display metadata related to the US 211 and enable update management by the administrator 117.

The security platform 141 may communicate the custom application package to the third-party system 116. The custom application package integrates the US 211 into a management service performed by the third-party system 116. In particular, the US 211 may be updated using the third-party system 116. For instance, the US developer system 147 may publish or post a patch for the US 211. In response, the security platform 141 may update a customer portal to indicate that there is an outstanding patch related to the US 211. The outstanding patch may be received by the third-party system 116 and distributed to the endpoints 106 for installation by the US 211.

The security platform 141 may then obtain post installation telemetry from the third-party system 116. For instance, the third-party system 116 may distribute a patch to the US 211 and use the post-install detection logic to determine whether the installation operation is successful. The post installation telemetry may include an indication of whether the product update was successfully installed, which further indicates whether the custom update application is functional. In response to an indication that the product update was not installed successfully, the security platform 141 may communicate a notification to the administrators 117 and/or prompt the administrators 117 to modify the custom update application. In response to an indication that the product update was installed successfully, the security platform 141 may indicate successful installation on a patch management user interface or via a notification.

Although one US 211 is depicted in the embodiment of FIG. 1. In other embodiments, multiple US 211 may be included in the products 115. In these embodiments, a custom update application and custom application package may be generated for each of the US 211. Additionally, in some embodiments as the US 211 changes (e.g., as the version, architecture, installation media, etc.), the custom update application may be modified.

In some embodiments, the security platform 141 may receive inventory data from the third-party system 116. The inventory data may indicate which of the products 115 are installed on the endpoints 106. The security platform 141 may evaluate the inventory data and identify which of the products 115 may be categorized as unsupported software (e.g., the US 211). The security platform 141 may initiate the custom application generation process by the application generator 150 for the identified unsupported software.

The security platform 141, the application generator 150, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the security platform 141, the application generator 150, the products 115, and components thereof may be implemented using a combination of hardware and software. Implementation in software may include rapid activation and deactivation of one or more transistors or transistor elements such as may be included in hardware of a computing system (e.g., the endpoints 106 or the management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more management devices 104, one or more endpoints 106, one or more local management devices 114, one or more third-party systems 116, one or more US developer systems 147, or any combination thereof. Moreover, the separation of various components and devices in the examples described herein is not meant to indicate that the separation occurs in all examples. Moreover, it may be understood with the benefit of this disclosure that the described components and servers may generally be integrated together in a single component or server or separated into multiple components or servers.

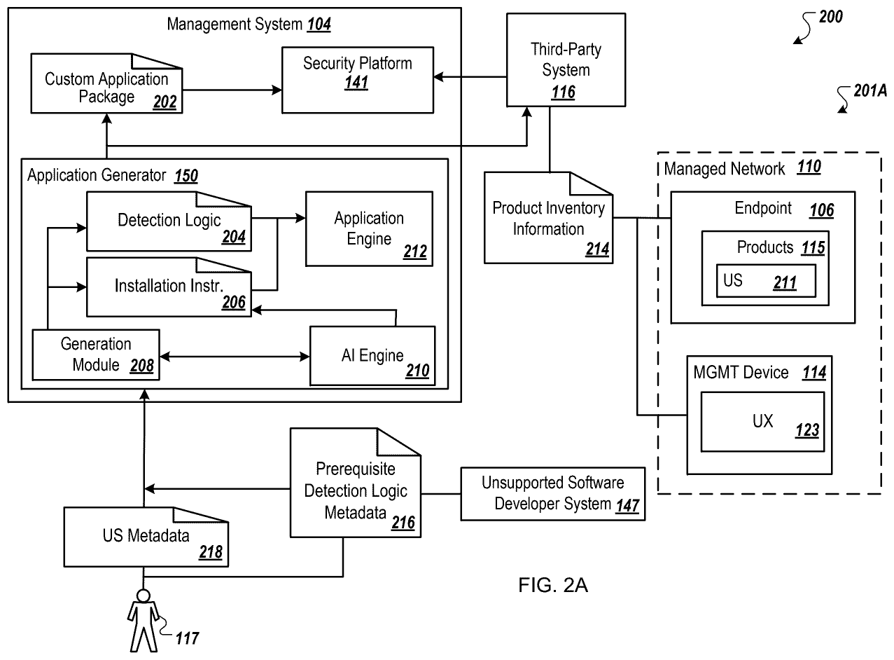

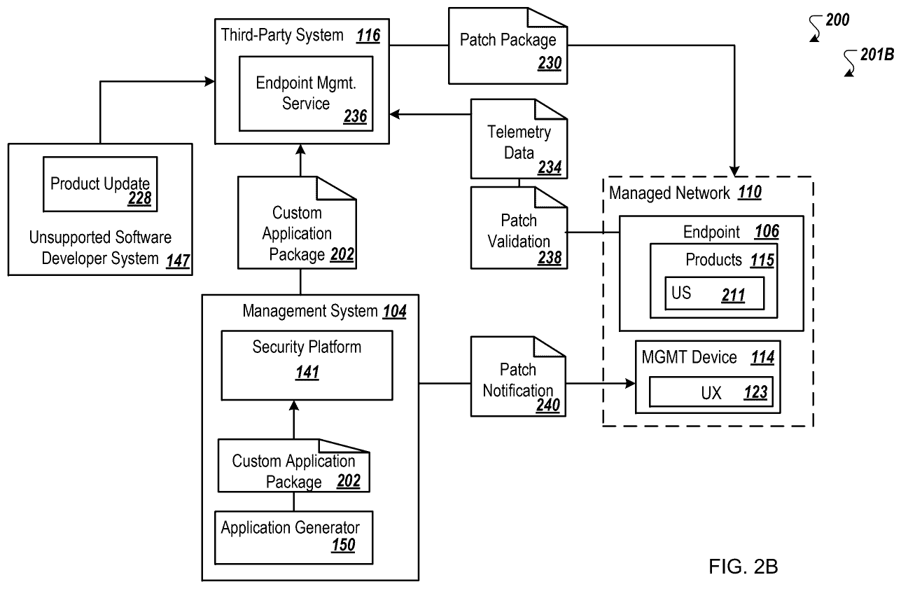

FIGS. 2A and 2B are block diagrams of product update management process (“process”) 200 that may be implemented in the operating environment 100 of FIG. 1 or another suitable environment. FIG. 2A depicts a setup phase 201A of the process 200. FIG. 2B depicts an implementation phase 201B of the process 200. FIGS. 2A and 2B include systems and components (e.g., 104, 150, 117, 114, 110, 116, 115, 123, etc.) described with reference to FIG. 1. Although not depicted in FIGS. 2A and 2B, communication of data and information in FIGS. 2A and 2B may be via a network such as the network 120 of FIG. 1.

The process 200 is implemented to generate and apply a custom application package 202. The custom application package 202 is used to effectively distribute product updates such as software patches and configuration changes to the US 211. In detail, the custom application package 202 enables incorporation of the US 211 into the security platform 141 and integration of the US 211 into the third-party system 116. In the setup phase 201A of FIG. 2A, the custom application package 202 is generated and incorporated into the security platform 141. In the implementation phase 201B of FIG. 2B, the custom application package 202 is used to distribute a patch package (in FIG. 2B, 230) to the US 211.

Referring to FIG. 2A, the setup phase 201A may begin with the application generator 150 receiving US metadata 218. The US metadata 218 may identify the US 211. In some embodiments, the US metadata 218 includes a title of the unsupported software, a version of the unsupported software, a vendor of the unsupported software, an installation media, an architecture of the unsupported software, other information, or combinations thereof. The title of the US metadata 218 may be the name of the US 211. The version may be a software version of the US 211. The vendor may be a name or identifier of the developer of or seller of the US 211 such as the US developer system 147 of FIG. 1. The installation media may include the URL of an installation source such as the URL of the US developer system 147. The architecture may include x86, x64, x86/x64 or another suitable architecture.

In some instances, a particular set of the US metadata 218 may be required. For example, in some embodiments, the title, the version, the vendor, and the installation media, and the architecture of the unsupported software may be required. In other embodiments, another subset of the information may be required. Additionally, in some embodiments, the US metadata 218 may be input from a user or an administrator such as through entry of the information via a user interface. Also, in some embodiments, some portion of the US metadata 218 may be pulled from the US 211 or previously generated custom update applications for other unsupported software (e.g., another version of the US 211).

The application generator 150 may obtain prerequisite detection logic metadata 216. The prerequisite detection logic metadata 216 is related to the US 211 as deployed in the managed network 110. For instance, the prerequisite detection logic metadata may be configured to identify one or more instance of the US 211 installed at the endpoints 106 included in the managed network 110. In some embodiments, the prerequisite detection logic metadata 216 may include a registry key, a file detection path, a script (such as a PowerShell script), a MSI product code, other detection logic metadata, or combinations thereof.

The prerequisite detection logic metadata 216 may be obtained by a generation module 208 of the application generator and the US metadata 218 may be received by the generation module 208. The generation module may generate post-install detection logic 204 and/or installation instructions 206. The post-install detection logic 204 may be generated based on the prerequisite detection logic metadata 216 in some implementations. For instance, in some embodiments, the prerequisite detection logic metadata 216 and the post-install detection logic 204 may be the same or may include common elements. For instance, in some embodiments, the prerequisite detection logic metadata 216 and the post-install detection logic 204 may both include a registry key, a file name for file detection; a PowerShell script, a MSI product code of the US 211, or some combination thereof.

The installation instructions 206 may be generated at least partially based on the prerequisite detection logic metadata in some instances. The installation instructions 206 may include commands and instructions implemented or install an update to the US 211. In some embodiments, the installation instructions 206 may include a custom installation command, a custom uninstall command, a set device restart behavior, set return codes that indicate a success or a failure of an update installation process, or some combination thereof.

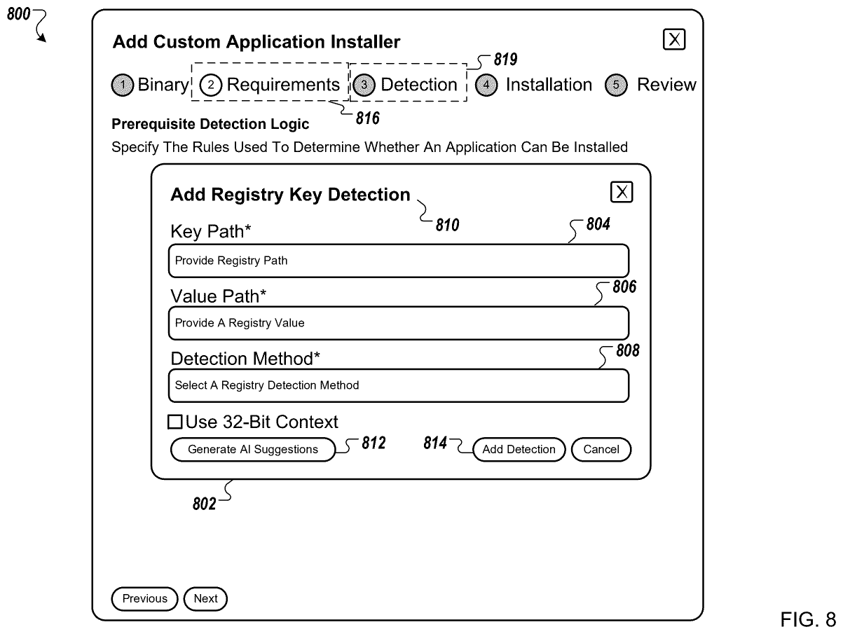

In some embodiments, the generating a post-install detection logic and/or installation instructions is implemented using an artificial intelligence (AI) engine 210. The AI engine 210 may be trained using one or more additional installation instructions and one or more additional post-install detection logic. For instance, in some embodiments, the application generator 150 may cause display of a button that enables the administrator 117 to use the AI engine 210. The AI engine 210 receives as input the name, version, and architecture of the US 211. A service API may communicate the input to a large language model (LLM) AI program in the form of a prompt. The LLM AI program may output to the API one or more suggested post-install detection logic 204, installation instructions 206, etc. An example of the AI engine 210 is provided in FIG. 8.

The post-install detection logic 204 and the installation instructions 206 may be communicated to an application engine 212. The application engine 212 may be configured pre-populated the security platform 141 with the custom application package 202 that is based on the post-install detection logic 204 and the installation instructions 206.

The security platform 141 may incorporate the custom application package 202 into the product update system or service. After the incorporation of the custom application package 202, updates to the US 211 are managed as a supported software application implemented in the managed network 110 as described with reference to FIG. 2B.

In some embodiments, product inventory information 214 may be accessed by the third- party system 116. The product inventory information 214 may include a list of the products 115, which includes the US 211 and potentially other unsupported software. The security platform 141 may access the product inventory information 214 from the third-party system 116. The security platform 141 may evaluate the product inventory information 214 to identify whether the products 115 include other unsupported software similar to the US 211. In response to the identification of the other unsupported software, the security platform 141 may initiate the setup phase 201A of the process 200 relative to the other unsupported software.

FIG. 2B depicts the implementation phase 201B of the process 200. The implementation phase 201B may occur following the setup phase 201A of FIG. 2A and may occur following a previous implementation phase 201B. For instance, the implementation phase 201B may be implemented for a first update to the US 211 (after the setup phase 201A) and then at least a portion of the implementation phase 201B may be repeated for a second update to the US 211.

The implementation phase 201B may begin by the security platform 141 and/or the third-party system 116 receiving an indication that there is an outstanding update for the US 211. In some embodiments, the US developer system 147 may find a vulnerability or inefficiency in the US 211. Accordingly, the US developer system 147 may generate and make available a product update 228. In some circumstances, the product update 228 may be posted at a website of the US developer system 147. In other circumstances, the US developer system 147 may communicate (e.g., via a network) to the security platform 141 and the third-party system 116. Along with the product update 228, the US developer system 147 may generate update metadata. The update metadata may provide information related to the product update 228. The update metadata may include, for instance, a criticality, patch identifiers, patch type, summary, vendor identifiers, vendor names, bulletin information, size, kb number, an affected product, links, or combinations thereof to the product update 228.

The third-party system 116 may generate a patch package 230. The patch package 230 may be generated for the US 211 based on the custom application package 202. For instance, the patch package 230 may include the product update 228 or a link (e.g., a URL) to the product update 228. Additionally, the patch package 230 may include the installation instructions 206, the post-install detection logic 204 or 216, scripts to implement the product update 228, etc. The patch package 230 may be generated responsive to the indication of the outstanding update. Additionally or alternatively, the third-party system 116 may generate the patch package 230 responsive to a selection by an administrator (e.g., 117 of FIG. 1) or responsive to a rule implemented by the security platform 141. The rule may automatically prompt the generation of the patch package 230 if the product update 228 addresses a vulnerability above a particular CVE score, for instance.

The third-party system 116 may distribute or cause distribution of the patch package 230. For instance, the third-party system 116 may include an endpoint management service module 236. The endpoint management service module 236 may be configured to implement an endpoint management service that includes communication of product updates (including the patch package 230) to the endpoint 106. The endpoint management service module 236 may include a specific set of conditions and instruction formats necessary to implement distribute the product updates.

The custom application package 202 may be generated to include the set of conditions and the instruction formats of the endpoint management service module 236. For instance, the third-party system 116 may include a Microsoft system and the endpoint management service may include Microsoft Intune. In these and other embodiments, the security platform 141 may communicate the custom application package 202 to the Microsoft Intune engine, to integrate the US 211 into the endpoint management service of the endpoint management service module 236.

The distribution of the patch package 230 may be caused such that the endpoint 106 receives and implements the patch package 230. Implementation of the patch package 230 includes causing installation of the product update 228 to change a state or configuration of the US 211 installed at the endpoint 106.

Following distribution of the patch package 230, the third-party system 116 may obtain post installation telemetry data 234 (in FIG. 2B “telemetry data”). the post installation telemetry data 234 includes a success or a failure message. The success message is included in the post installation telemetry data 234 in circumstances in which the product update 228 is successfully installed at the endpoint 106 to modify the US 211. The failure message is included in the post installation telemetry data 234 in circumstances in which the product update 228 is not installed at the endpoint 106. In response to the failure message, the setup phase 201A may be repeated to modify an aspect of the custom application package 202. In addition, in some embodiments a patch validation 238 may be communicated by the endpoint 106. The patch validation 238 may ensure that the product update 228 operates properly (e.g., does not interfere with other products, does not disable another feature of another of the products 115, etc.). The security platform 141 may obtain the patch validation 238 and the post installation telemetry data 234 from the third-party system 116.

The security platform 141 may communicate notifications (in FIG. 2B, “patch notification”) 240. For instance, the security platform 141 may communicate the notification 240 to the local management device 114 or another administrative device. For instance, the administrative device may be notified of a successful installation or an unsuccessful installation of the product update 228 using the patch package 230 at the endpoint 106.

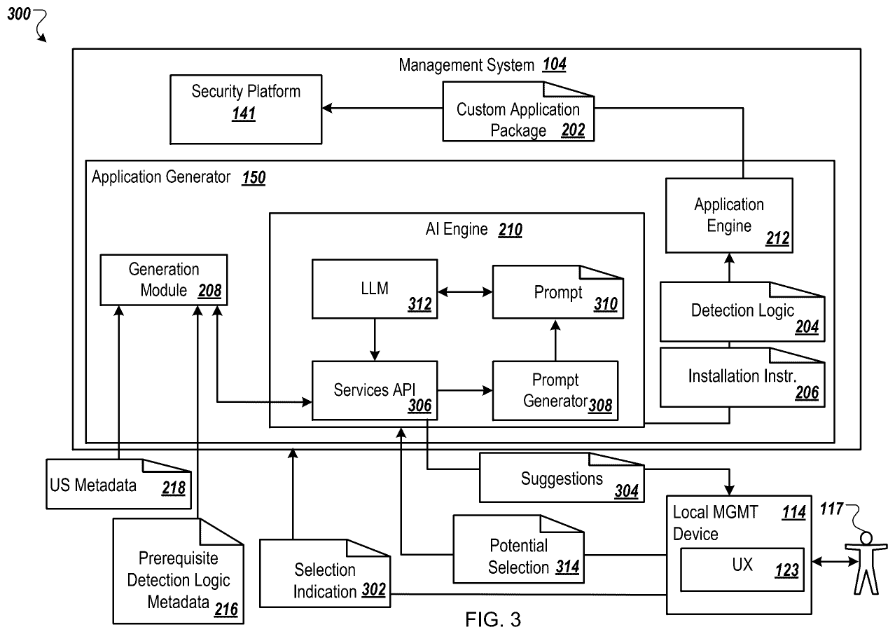

FIG. 3 depicts a block diagram of an Al-based logic and instruction generation process (AI process) 300 that may be implemented in the process 200 of FIGS. 2A and 2B. The AI process 300 of FIG. 3 includes systems and components described with reference to FIGS. 1-2B. Although not depicted in FIG. 3, the communication of data and information may be via a network such as the network 120 of FIG. 1.

The AI process 300 may be implemented to generate the post-install detection logic 204 and/or the installation instructions 206 described with reference to FIG. 2A. The AI process 300 may be conducted at least partially by the AI engine of 210 after the US metadata 218 and the prerequisite detection logic metadata 216 is received and obtained by the application generator 150. The AI process 300 may be optionally implemented. For instance, the administrator 117 may initiate the AI process 300 through a selection made at the UX 123 or a selection made at the management device 104 via a browser that is displayed at the UX 123. Accordingly, the AI process 300 may begin by the management device 104 receiving a selection indication 302 that AI suggestions is desired, which may trigger the AI process 300. In some embodiments, the selection indication 302 is received by the security platform 141. In other embodiments, the selection indication 302 may be received by the application generator 150. Additionally, in some embodiments, the AI process 300 may not be optional. In these embodiments the AI process 300 may occur each time the custom application package 202 is generated. Thus, in these and other embodiments, no selection indication 302 is included in the AI process 300.

In response to receipt of the selection indication 302, a service API 306 may be used to package and communicate the US metadata 218 and/or the prerequisite detection logic metadata 216 to a prompt generator 308. The prompt generator 308 may receive the US metadata 218 and/or the prerequisite detection logic metadata 216. The prompt generator 308 may validate the US metadata 218 and/or the prerequisite detection logic metadata 216 and generate a prompt 310 based thereon. The prompt 310 may be configured as input to a large language model (LLM) 312. Some examples of the LLM may include Azure OpenAI™ or another suitable LLM. The LLM 312 may output suggestions 304 of potential post-install detection logic and potential installation instructions to the local management device 114 via the service API 306. In some embodiments, the suggestions 304 might include three potential post-install detection logic and three potential installation instructions. In other embodiments, the suggestions 304 may include more than three or less than three potential post-install detection logic and installation instructions.

The suggestions 304 may be displayed to the administrator 117 at the UX 123. The administrator 117 may select a subset of the suggestions 304. A potential selection 314 may be communicated to the AI engine 210. In response to the potential selection 314, the post-install detection logic 204 and the installation instructions 206 are output by AI engine 210 to the application engine 212. The application engine 212 may generate the custom application package 202 based on the post-install detection logic 204 and the installation instructions 206.

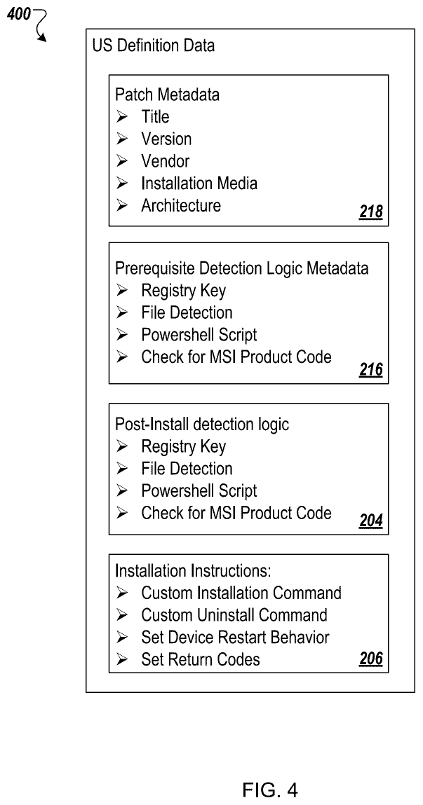

FIG. 4 depicts a block diagram of example US definition data 400. The US definition data 400 provides a list of data and data types involved in the generation of the custom update application such as the custom application package 202. In the US definition data 400, the US metadata 218 includes a title, version, vendor, installation media, and architecture. The prerequisite detection logic metadata 216 may include a registry key, file detection, PowerShell Script, and MSI product code to check for. Similarly, the post-install detection logic 204 may include the registry key, the file detection, the PowerShell Script, and the MSI product code to check for. The installation instructions 206 may include one or more custom installation commands, one or more custom uninstall commands, device restart behaviors, and set return codes. In other embodiments, the US definition data 400 may include other, similar data or data types.

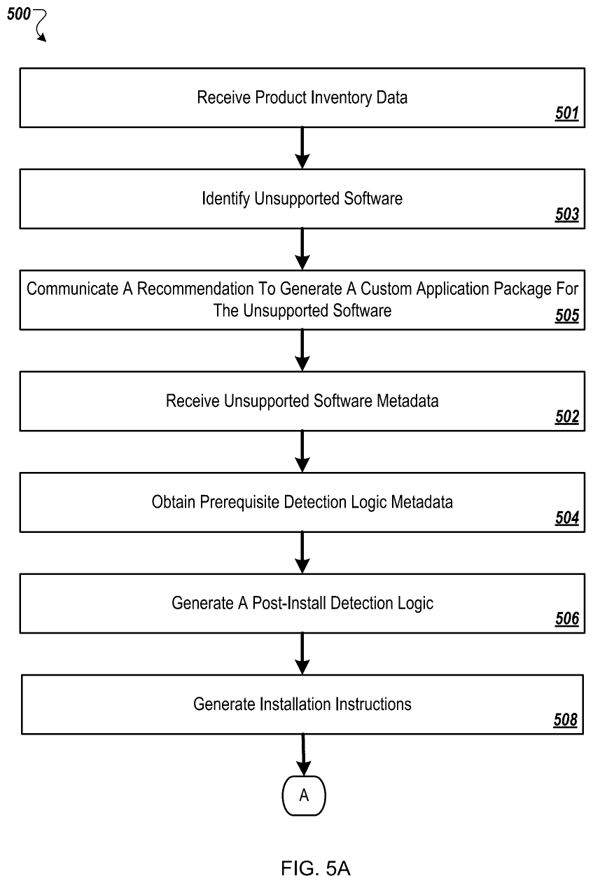

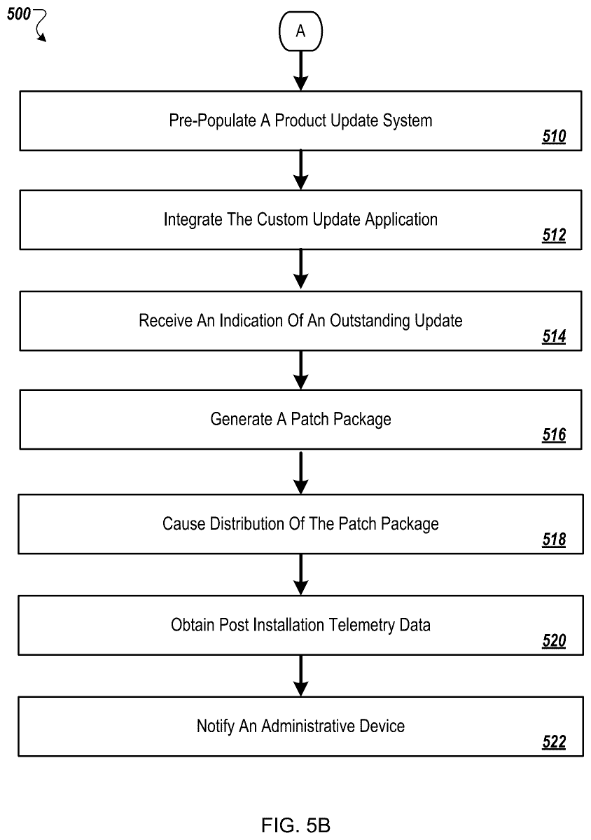

FIGS. 5A and 5B are a flow chart of an example method 500 of product update management of unsupported software in a managed network, according to at least one embodiment of the present disclosure. The method 500 may begin at block 501 in which product inventory data is received. For instance, a third-party system may obtain product information from an endpoint. The product information may include product inventory data indicative of products installed at the endpoint. At block 503, unsupported software (“US” elsewhere in the present disclosure) may be identified. The unsupported software may be identified from the product inventory data. For instance, of the products installed at the endpoint, there may be a first subset of the products that are managed by default by the third- party system. There may also be a second subset of products that are managed by a service provider that interfaces with the third-party system. The unsupported software may include the products not included in the first and the second subsets of the products.

At block 505, a recommendation to generate a custom application or a custom application package for the identified unsupported software may be communicated. The recommendation may initiate or prompt one or more operations of the method 500. In some embodiments, the method 500 may omit blocks 501, 503, and 505. For instance, the remaining operations of the method 500 may be initiated by an administrator without the recommendation.

At block 502, unsupported software information may be received. The unsupported software information may identify an unsupported software. The unsupported software includes a software application that is not updated by a product update system such as the security platform 141 and the third-party system 116 of FIGS. 1-2B. In some embodiments, the unsupported software information includes a title of the unsupported software, a version of the unsupported software, a vendor of the unsupported software, an installation media, an architecture of the unsupported software, other information, or combinations thereof. In some instances, a particular set of the unsupported software information may be required. For example, in some embodiments, the title, the version, the vendor, and the installation media, and the architecture of the unsupported software may be required. In other embodiments, another subset of the information may be required. Additionally, in some embodiments, the unsupported software information may be input from a user or an administrator such as through entry of the information via a user interface. In other embodiments, some portion of the information may be pulled from the unsupported software.

At block 504, prerequisite detection logic metadata may be obtained. The prerequisite detection logic metadata is related to the unsupported software as deployed in a managed network. For instance, the detection logic metadata may be configured to identify an instance of the unsupported software installed at an endpoint included in the managed network.

At block 506, a post-install detection logic may be generated. The post-install detection logic may be generated based on the prerequisite detection logic metadata in some implementations. In some embodiments, the prerequisite detection logic metadata and the post-install detection logic may be the same or may include common elements. For instance, in some embodiments, the prerequisite detection logic metadata and the post-install detection logic may include a registry key, a file name for file detection; a PowerShell script, a MSI product code of the custom update application, or some combination thereof.

At block 508, installation instructions may be generated. The installation instructions may be generated at least partially based on the prerequisite detection logic metadata in some instances. The installation instructions may include commands and instructions implemented or install an update to the unsupported software. In some embodiments, the installation instructions may include a custom installation command, a custom uninstall command, a set device restart behavior, set return codes, or some combination thereof. In some embodiments, the generating a post-install detection logic and/or installation instructions is implemented using an artificial intelligence (AI) engine. The AI engine may be trained on one or more additional installation instructions and one or more additional post-install detection logic.

Referring to FIG. 5B, at block 510, a product update system may be pre-populated. The product update system may be pre-populated with the prerequisite detection logic metadata, the post install detection logic, and the installation instructions to generate a custom update application for the unsupported software. At block 512, the custom update application may be integrated into the product update system such that management of the unsupported software is managed as a supported software application implemented in the managed network. At block 514, an indication of an outstanding update may be received. The indication of the outstanding update may include a communication or a post that there is an outstanding update to the unsupported software.

At block 516, a patch package may be generated. The patch package may be generated for the unsupported software based on the custom update application. The patch package may be generated responsive to the indication of the outstanding update. At block 518, distribution of the patch package may be caused. For instance, the distribution of the patch package may be caused such that the endpoint receives and implements the patch package. Implementation of the patch package may include causing a change in a state of the unsupported application installed at the endpoint. In some embodiments, the causing distribution of the patch package includes distribution of the patch package to a third-party service provider. For instance, the patch package may be communicated to an endpoint management service, such as Microsoft Intune. The endpoint management service may distribute the patch package to the endpoint.

At block 520, post installation telemetry data is obtained. The post installation telemetry data may be from the endpoint or the third-party system following the installation or attempted installation of the patch. At block 522, an administrative device may be notified. The administrative device may be notified of a successful installation or an unsuccessful installation of a patch using the patch package at the endpoint.

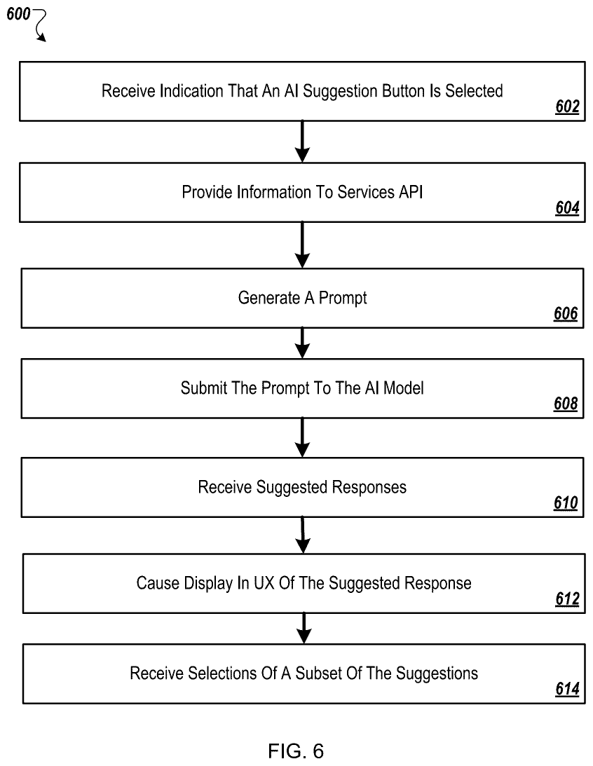

FIG. 6 is a flow chart of an example method 600 of AI-based logic and instruction generation, according to at least one embodiment of the present disclosure. The method 600 may be implemented as part of another method such as block 508 of the method 500 described above. The method 600 may begin at block 602 in which an indication is received that an AI suggestion button is selected. For instance, an administrator may select an AI suggestion button or another suitable button in a user interface, which may trigger AI-based generation of logic and instructions.

At block 604, information may be provided to a services API. The information may include US metadata and/or prerequisite detection logic metadata, for instance. The information may be received and obtained previously or auto-filled based on previous custom update application generation. At block 606, a prompt may be generated. For instance, the services API may receive the information and communicate the information to a prompt generator, which may generate the prompt. The prompt is configured as input to an AI model such as an LLM. At block 608, the prompt may be submitted to an AI model. For instance, the prompt may be submitted as an input to the LLM to generate suggested instructions and detection logic for a US. In some embodiments, multiple suggested instructions and detection logic may be output by the LLM.

At block 610, suggested responses may be received. The suggested responses may be received from the services API in some embodiments. The services API may be configured to communicate the suggested responses (i.e., including the suggested instructions and detection logic for the US). At block 612, display of the suggested responses may be caused. For instance, the suggested responses may be displayed in a user interface. The user interface may enable selection of one or more of the suggested responses.

At block 614, selections of the suggested responses may be received. The selections of the suggested responses may be received via the user interface. For instance, the administrator may select one or more of the suggested responses and indication of such selection may be communicated to a system generating a custom update application. The selected, suggested responses are then received by the system and used to generate the custom update application.

Although illustrated as discrete blocks, one or more blocks in FIGS. 5A, 5B, and 6 may be divided into additional blocks, combined into fewer blocks, or eliminated, depending on the desired implementation. One or more of the methods described in the present disclosure may be performed in a suitable operating environment such as the operating environment 100. The methods 500 and 600 may be performed by the management device 104 or another computing device (e.g., 700 of FIG. 7). In some embodiments, the management device 104 or another computing system may include or may be communicatively coupled to a non- transitory computer-readable medium (e.g., the memory 712 of FIG. 7) having stored or encoded thereon programming code or instructions that are executable by one or more processors (such as the processor 710 of FIG. 7) to cause a computing system or the management device 104 to perform or control performance of the methods 500 and 600. Additionally or alternatively, the management device 104 or another computing device may include the processor 710 described elsewhere in this disclosure that is configured to execute computer instructions to cause the management device 104 or another computing systems to perform or control performance of the methods.

FIG. 7 illustrates an example computer system 700 configured of product update management of unsupported software in a managed network, according to at least one embodiment of the present disclosure. The computer system 700 may be implemented in the operating environment 100 of FIG. 1 or another suitable operating environment. Examples of the computer system 700 may include the management device 104, the third-party system 116, the endpoint 106, the local management device 114, the US developer system 147, or some combination thereof. The computer system 700 may include one or more processors 710, a memory 712, a communication unit 714, a user interface device 716, and a data storage 704 that includes the products 115, the application generator 150, and the security platform 141 (collectively, modules 705).

The processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 7, the processor 710 may more generally include any number of processors configured to perform individually or collectively any number of operations described in the present disclosure. Additionally, one or more of the processors 710 may be present on one or more different electronic devices or computing systems. In some embodiments, the processor 710 may interpret and/or execute program instructions and/or process data stored in the memory 712, the data storage 704, or the memory 712 and the data storage 704. In some embodiments, the processor 710 may fetch program instructions from the data storage 704 and load the program instructions in the memory 712. After the program instructions are loaded into the memory 712, the processor 710 may execute the program instructions.

The memory 712 and the data storage 704 may include computer-readable storage media for carrying or having computer-executable instructions or data structures stored thereon. Such computer-readable storage media may include any available media that may be accessed by a general-purpose or special-purpose computer, such as the processor 710. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

The communication unit 714 may include one or more pieces of hardware configured to receive and send communications. In some embodiments, the communication unit 714 may include one or more of an antenna, a wired port, and modulation/demodulation hardware, among other communication hardware devices. In particular, the communication unit 714 may be configured to receive a communication from outside the computer system 700 and to present the communication to the processor 710 or to send a communication from the processor 710 to another device or network (e.g., the network 120 of FIG. 1).

The user interface device 716 may include one or more pieces of hardware configured to receive input from and/or provide output to a user. In some embodiments, the user interface device 716 may include one or more of a speaker, a microphone, a display, a keyboard, a touch screen, or a holographic projection, among other hardware devices.

The modules 705 may include program instructions stored in the data storage 704. The processor 710 may be configured to load the modules 705 into the memory 712 and execute the modules 705. Alternatively, the processor 710 may execute the modules 705 line-by-line from the data storage 704 without loading them into the memory 712. When executing the modules 705, the processor 710 may be configured to perform one or more processes or operations described elsewhere in this disclosure.

Modifications, additions, or omissions may be made to the computer system 700 without departing from the scope of the present disclosure. For example, in some embodiments, the computer system 700 may not include the user interface device 716. In some embodiments, the different components of the computer system 700 may be physically separate and may be communicatively coupled via any suitable mechanism. For example, the data storage 704 may be part of a storage device that is separate from a device, which includes the processor 710, the memory 712, and the communication unit 714, that is communicatively coupled to the storage device. The embodiments described herein may include the use of a special-purpose or general-purpose computer including various computer hardware or software modules, as discussed in greater detail below.

FIG. 8 is a screenshot of an example first user interface (UX) 800 that may be implemented in the process 200 of FIGS. 2A and 2B. The prerequisite detection logic metadata may be entered into the first UX 800. In the first UX 800, a “requirements” portion is selected, which is generally indicated by dashed box 816. The selection of the “requirements” may cause display of a first entry window 802. In the first entry window 802, a title 810 “Add Registry Key Detection” is displayed along with three entry fields 804, 806, and 808. A first entry field 804 requests a “registry path,” a second entry field 806 requests a “registry value,” and a third entry field 808 requests a detection method. In each of the three entry fields 804, 806, and 808 an administrator may enter information or one or more of the three entry fields 804, 806, and 808 may be auto populated. The first UX 800 also includes an “add detection” button 814. After information is provided to the entry fields 804, 806, and 808, selection of the add detection button 814 inputs the data from the entry fields 804, 806, and 808 into the application generator (e.g., application generator 150 of FIGS. 1-2B).

The first UX 800 includes a generate AI suggestions button 812. Selection of the generate AI suggestions button 812 triggers utilization of the AI engine 210 such as triggering the AI process 300 of FIG. 3. The AI engine 210 may then communicate data and information to the three entry fields 804, 806, and 808.

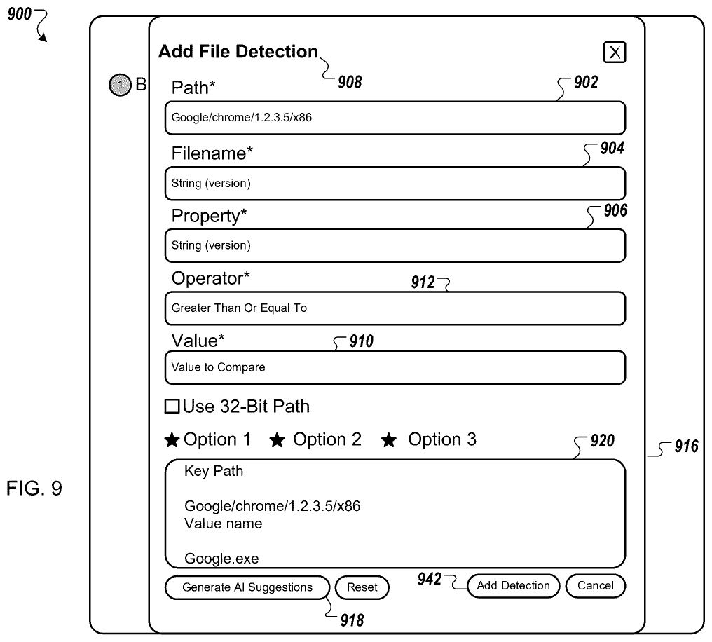

FIG. 9 is a screenshot of an example second UX 900 that may be implemented in the process 200 of FIGS. 2A and 2B. The post-install detection logic may be entered into the second UX 900. Referring to FIG. 8, selection of a “detection” portion, which is generally indicated by dashed box 819, may cause display of a second entry window 916 of FIG. 9. The “detection” portion of FIG. 9 is covered by the second entry window 916.

Referring back to FIG. 9, in the second entry window 916, a title 908 “Add File Detection” is displayed along with five entry fields 902, 904, 906, 910, and 912. A first entry field 902 requests a “path,” to the US. The second entry field 904 requests a “filename” of the US. A third entry field 906 requests a property to be detected. For instance, the property may include the version of the US. The fourth entry field 912 is an operator that is performed relative to the property listed in the third entry field 906. The fifth entry field 910 requests a value that is compared to the property listed in the third entry field 906.

The second UX 900 also includes an “add detection” button 942. After information is provided to the entry fields 902, 904, 906, 910, and 912, selection of an add detection button 942 inputs the data from the entry fields 804, 806, and 808 into the application generator (e.g., application generator 150 of FIGS. 1-2B).

The second UX 900 includes a generate AI suggestions button 918. Selection of the generate AI suggestions button 918 triggers utilization of the AI engine 210 such as triggering the AI process 300 of FIG. 3. The AI engine 210 may then communicate suggestions, which may be presented as “Option 1,” “Option 2,” and “Option 3” and the context of the suggestions may be presented in an option field 920 of the second UX 900.

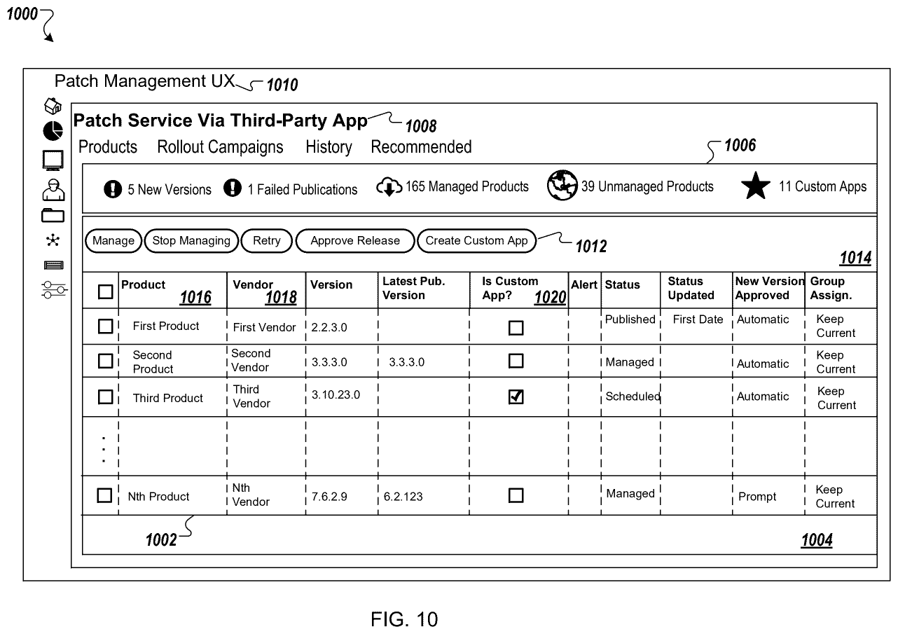

FIG. 10 depicts an example patch management UX 1000 that may be implemented in the process 200 of FIGS. 2A and 2B. The patch management UX 1000 is an example of a customer portal that may display to an administrator the products for which updates are managed. For instance, the patch management UX 1000 may be displayed on UX 123 of FIG. 1. The administrator 117 may be able to see and interface with the patch management UX 1000 using the local management device 114. Additionally or alternatively, the security platform 141 may cause display of the patch management UX 1000 via the network 120. The patch management UX 1000 may be visible to the administrator 117 and may enable interaction with the patch management UX 1000.

The patch management UX 1000 includes a products portion 1004 and an alerts banner 1006. The alerts banner 1006 includes one or more pieces of consolidated data that might be of interest to an administrator. For instance, the alerts banner 1006 indicates a number of new versions, a number of failed publications, a number of managed products, a number of unmanaged products, and a number of custom update applications (e.g., the number of custom application packages 202 of FIG. 2) under management.

The products portion 1004 includes action buttons portion 1014 and a table 1002. The action buttons portion 1014 includes some example action buttons such as “manage,” “stop managing,” “retry,” “approve release,” and “create custom app” 1012. The manage and stop manage buttons add and remove, respectively, products from management. Accordingly, following selection of one of the products from the table 1002 and selection of the “stop managing” action button, product updates for the selected product are not packaged and distributed. Similarly, following selection of one of the products from the table 1002 and selection of the “managing” action button, product updates for the selected product are packaged and distributed. The retry action button attempts to distribute a patch package for a selected product after a failed installation by a third-party system (e.g., 116 of FIGS. 1-2B). The approve release action button generates and communicates an instruction configured to cause the third-party system to distribute a patch. The create custom app 1012 action button initiates or triggers the process 200 or at least the setup phase 201A of FIGS. 2A and 2B to generate a custom update application.

The table 1002 includes a listing of the products (e.g., 115 of FIGS. 1-2B) under management as well as metadata and status information of each of the products. For instance, the table 1002 includes a first column 1016 in which the products are listed. The table 1002 includes a second column 1018 in which vendors of the products are listed. The version, latest published version, alert, status, etc. are listed in the remaining columns of the table 1002.

In a third column 1020 of the table 1002, there is an indication of whether the product is integrated using a custom update application (e.g., 202 of FIGS. 2A and 2B). For instance, following generation of the custom update application, it may be integrated in a security platform such that the US is managed similarly to supported products.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of product update management of unsupported software in a managed network, the method comprising:
receiving unsupported software information that identifies an unsupported software, the unsupported software including a software application that is not updated by a third-party system or a product update system that augments management services of the third-party system;
obtaining prerequisite detection logic metadata related to the unsupported software as deployed in a managed network, the prerequisite detection logic metadata being configured to identify an instance of the unsupported software installed at an endpoint included in the managed network;
generating a post-install detection logic and installation instructions at least partially based on the prerequisite detection logic metadata;
pre-populating a product update system with the prerequisite detection logic metadata, the post-install detection logic, and the installation instructions to generate a custom application package for the unsupported software; and
communicating the custom application package to the third-party system such that the third-party system integrates the unsupported software into a management service configured to distribute product updates to the endpoint and such that responsive to an indication of a product update directed to the unsupported software, the third-party system generates and distributes a patch package for the unsupported software based on the custom application package.

2. The method of claim 1, further comprising:
obtaining post installation telemetry data from the third-party system; and
notifying an administrative device of a successful installation or an unsuccessful installation of a patch using the patch package at the endpoint.

3. The method of claim 1, wherein the generating a post-install detection logic and installation instructions is implemented using an artificial intelligence engine that is trained on one or more additional installation instructions and one or more additional post-install detection logic.

4. The method of claim 1, wherein the unsupported software information includes:
a title of the unsupported software;
a version of the unsupported software;
a vendor of the unsupported software;
an installation media; and
an architecture of the unsupported software.

5. The method of claim 1, wherein the prerequisite detection logic metadata and the post-install detection logic includes:
a registry key;
a file name for file detection;
a PowerShell script; and
a MSI product code.

6. The method of claim 1, wherein the installation instructions include:
a custom installation command;
a custom uninstall command;
a set device restart behavior; and
set return codes that indicate a success or a failure of an update installation process.

7. The method of claim 1, further comprising incorporating the custom application package into the product update system such that management of the unsupported software is managed as a supported software application implemented in the managed network.

8. The method of claim 1, further comprising:
receiving, from the third-party system, product inventory data;
based on the product inventory data, identifying the unsupported software; and
communicate a recommendation to generate the custom application package for the unsupported software.

9. A non-transitory computer-readable medium having encoded therein programming code executable by one or more processors to perform or control performance of operations of product update management of unsupported software in a managed network, the operations comprising:
receiving unsupported software information that identifies an unsupported software, the unsupported software including a software application that is not updated by a third-party system or a product update system that augments management services of the third-party system;
obtaining prerequisite detection logic metadata related to the unsupported software as deployed in a managed network, the prerequisite detection logic metadata being configured to identify an instance of the unsupported software installed at an endpoint included in the managed network;
generating a post-install detection logic and installation instructions at least partially based on the prerequisite detection logic metadata;
pre-populating a product update system with the prerequisite detection logic metadata, the post-install detection logic, and the installation instructions to generate a custom application package for the unsupported software; and
communicating the custom application package to the third-party system such that the third-party system integrates the unsupported software into a management service configured to distribute product updates to the endpoint and such that responsive to an indication of a product update directed to the unsupported software, the third-party system generates and distributes a patch package for the unsupported software based on the custom application package.

10. The non-transitory computer-readable medium of claim 9, further comprising:
obtaining post installation telemetry data from the third-party system; and
notifying an administrative device of a successful installation or an unsuccessful installation of a patch using the patch package at the endpoint.

11. The non-transitory computer-readable medium of claim 9, wherein the generating a post-install detection logic and installation instructions is implemented using an artificial intelligence engine that is trained on one or more additional installation instructions and one or more additional post-install detection logic.

12. The non-transitory computer-readable medium of claim 9, wherein the unsupported software information includes:
a title of the unsupported software;
a version of the unsupported software;
a vendor of the unsupported software;
an installation media; and
an architecture of the unsupported software.

13. The non-transitory computer-readable medium of claim 9, wherein the prerequisite detection logic metadata and the post-install detection logic includes:
a registry key;
a file name for file detection;
a PowerShell script; and
a MSI product code.

14. The non-transitory computer-readable medium of claim 9, wherein the installation instructions include:
a custom installation command;
a custom uninstall command;
a set device restart behavior; and
set return codes that indicate a success or a failure of an update installation process.

15. The non-transitory computer-readable medium of claim 9, wherein the operations further comprise incorporating the custom application package into the product update system such that management of the unsupported software is managed as a supported software application implemented in the managed network.

16. The non-transitory computer-readable medium of claim 9, wherein the operations further comprise:
receiving, from the third-party system, product inventory data;
based on the product inventory data, identifying the unsupported software; and
communicate a recommendation to generate the custom application package for the unsupported software.
